(19) United States
(12) Patent Application Publication
(10) Pub. No.: US 2022/0151376 A1
(43) Pub. Date: May 19, 2022

(54) SYSTEM AND METHOD FOR IMPROVED OVERBED TABLE

(71) Applicant: Janelle White, Yeadon, PA (US)

(72) Inventor: Janelle White, Yeadon, PA (US)

(21) Appl. No.: 17/529,235

(22) Filed: Nov. 17, 2021

Related U.S. Application Data
(60) Provisional application No. 63/115,007, filed on Nov. 17, 2020.

(51) Int. Cl. A47B 23/06; G08B 7/06

(52) U.S. Cl. CPC A47B 23/06; G08B 7/06

(57) ABSTRACT

A system and method for an improved overbed table adapted to fit on top of standard hospital beds that may be accessible to the patient lying on the bed, the overbed having a refrigerator providing storage for cold food and drinks with a doubled sided access door allowing for a caregiver to place contents in the refrigerator through one door while permitting a patient to access the contents from the other door.

### CROSS REFERENCE TO RELATED APPLICATIONS

This application is a non-provisional application which claims priority to U.S. Provisional Application No. 63/115,007 filed on Nov. 17, 2020, which is incorporated by reference in its entirety.

### FIELD OF THE DISCLOSURE

This disclosure relates generally to the field of tables and more particularly to overbed tables adapted to fit on top of standard hospital beds that may have various features to provide comfort to the patient.

### BACKGROUND

Hospital patients spend the majority of their time in bed, making an overbed table can be a highly useful piece of furniture. Overbed tables are specially designed to fit over a bed. Overbed tables allows a patient to easily and enjoyably perform a variety of activities while remaining in bed such as eating and drinking as well as tasks like reading and writing. Care providers such as nurses may fall behind or become stretched thin while caring for multiple patients. Currently, no hospital furniture has been designed to solve many of these tasks carried out by the care providers and thus a new and improved overbed table is needed.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is an illustration the embodiment of the overbed table.

FIG. 2 is a view of the outlet strip.

FIG. 3 is a view of the accessory mount.

FIG. 4 is a view of the retractable table.

FIG. 5 is a view of the fridge and the drawer.

FIG. 6 is a view of the ice and water dispenser.

FIG. 7 is a view of the inside of the ice and water dispenser.

FIG. 8 is a view of the support column in an upward position and downward position.

FIG. 9 depicts other views of the overbed table.

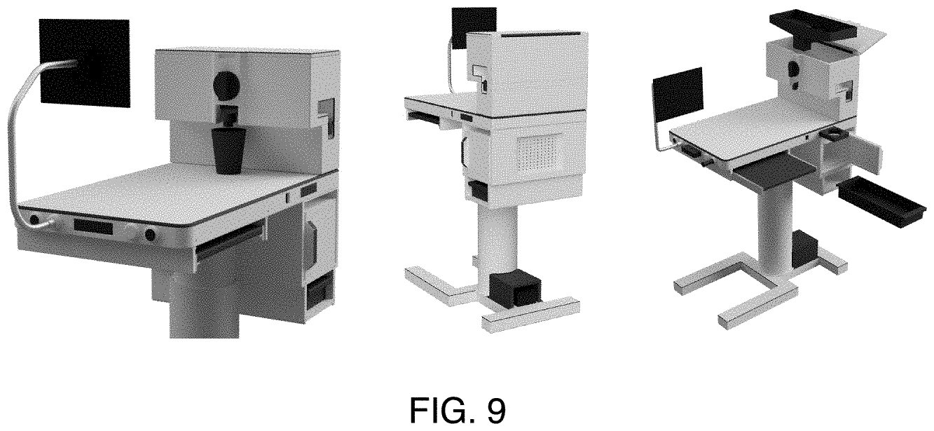

FIG. 10 is a block diagram illustrating the components of a computing device.

FIG. 11 is a block diagram illustrating the components connectable to overbed table.

### SUMMARY

It is one object of the present invention to provide a system an overbed table, the overbed table comprising a base, a support column extending upwardly from the base, and a support surface assembly connected to the support column, wherein the base has a pair of semi discorectangle spaced apart prongs separated by an interior space wherein the prongs at a first end have curved ends, wherein the base is connected to a plurality of wheels for transporting the overbed table, wherein the support column has a lower component and upper component where the upper component is movable in relation to the lower component in a linear telescopic motion so that a height of the support column is increasable or decreasable, wherein the support surface assembly has one or more drawers, wherein the one or more drawers are insertable into openings in the support surface assembly, wherein the one or more drawers are positioned above support surfaces attached to a bottom of the support surface assembly, wherein the support surface assembly has one or more retractable cup holders, wherein the support surface assembly has one or more light sources attached to a perimeter of a top surface of the support surface assembly, wherein the one or more light sources are connected to a control system, wherein the control system performs steps of: flashing colors when events occur with equipment for treating a patient, wherein the support surface assembly has one or more power and charging receptacles, wherein the support surface assembly has a speaker assembly and microphone assembly for sending and receiving notifications concerning a patient, wherein the support surface assembly has a refrigerator, wherein the refrigerator is detachable and has two hinged doors on a front surface and a back surface, wherein the refrigerator has one or more partitions and compartments within the refrigerator, wherein the support surface assembly has a water dispenser, wherein the water dispenser is connected to the refrigerator by one or more tubes, the one or more tubes in fluid communication with a pump.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description includes one or more embodiments for an improved overbed table adapted to fit on top of standard hospital beds that may be accessible to the patient lying on the bed. The overbed table may have a refrigerator providing storage for cold food and drinks with a doubled sided access door allowing for a caregiver or other personnel to place contents in the refrigerator through one door while permitting a patient to access the contents from the other door. The overbed table may also have a water or ice dispenser. The overbed table may have one or more electric outlets for charging phones or powering small appliances. The overbed table may have powered height adjustment features with buttons for easier control. The overbed table may have an alarm for contacting hospital staff. The overbed table may include entertainment systems such as tablets or TV screens.

Elements included herein are meant to be illustrative rather than restrictive. Persons having ordinary skill in the art relevant to the present disclosure may understand there to be equivalent elements that may be substituted with the present disclosure without changing the essential function or operation of the controller.

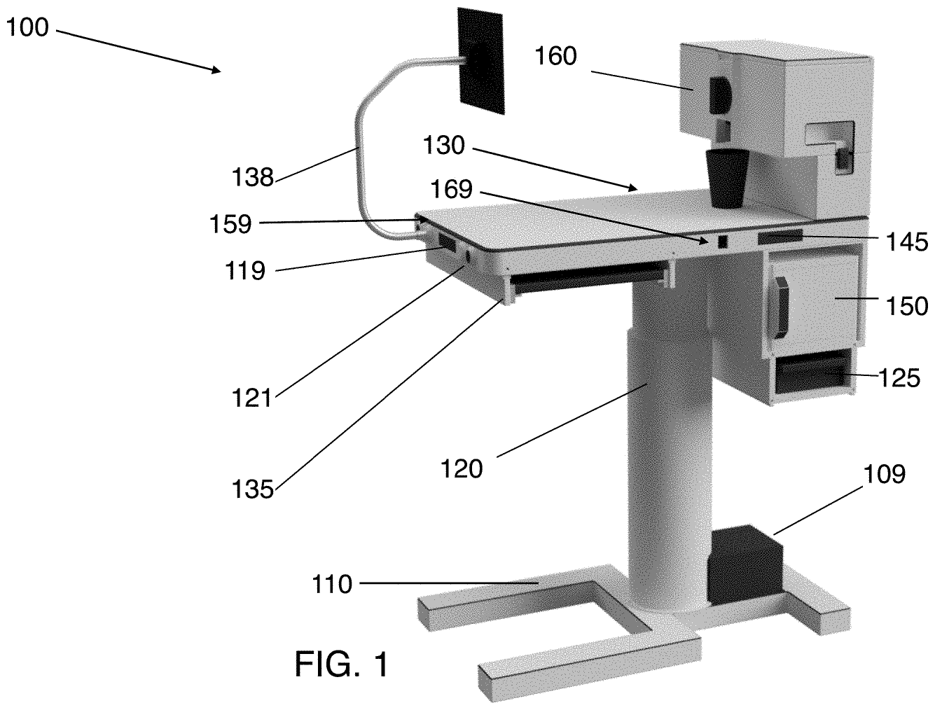

Referring to FIG. 1 provides an example of an overbed table according to an illustrative embodiment. FIG. 1 shows a left side perspective view of the overbed table 100 and FIG. 1B provides a rear view of the overbed table 100.

Overbed table 100 may have a power system designed to provide energy to the circuits and components of overbed table 100 during the process of operating overbed table 100. Overbed table 100 may be powered by methods known by those of ordinary skill in the art. In some embodiments, overbed table 100 may plug into an electrical outlet using an electrical cord to supply power to the circuits and components of overbed table 100. Further, the power system may include a rechargeable battery pack whereby the rechargeable battery is of a charge, design, and capacity, to provide sufficient power to the circuits and components of overbed table 100 during operation for a set period of time.

In one or more non-limiting embodiments, overbed table 100 may have one or more battery compartments 109 for receiving and holding batteries, such as but not limited to AA or AAA sized conventional batteries. Battery compartment 109 may include one or more electrodes (e.g., conventional electrodes) that are configured to contact electrically conductive surfaces of the battery received inside the compartment. Battery compartment 109 may be selectively accessible by removal of a latch cover whereby the battery compartments and the batteries are accessible only when the user removes a removable battery cover or latch mechanism concealing the battery compartment from external view. Overbed table 100 may include a latch receiving component that engages with the latch cover concealing battery compartment to facilitate removal and reattachment of the latch cover from overbed table 100.

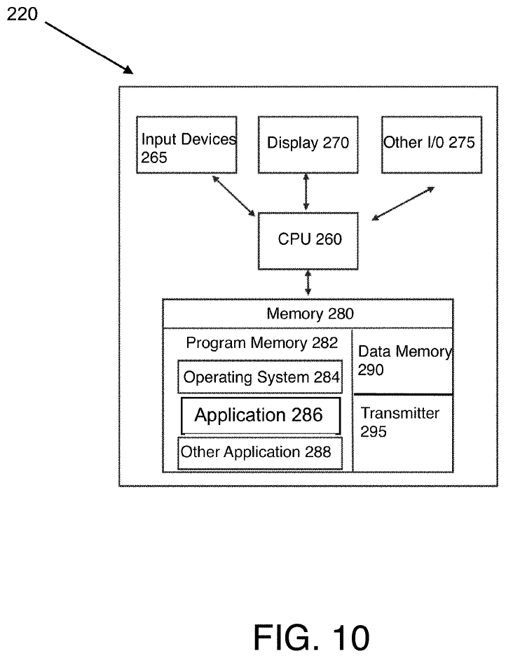

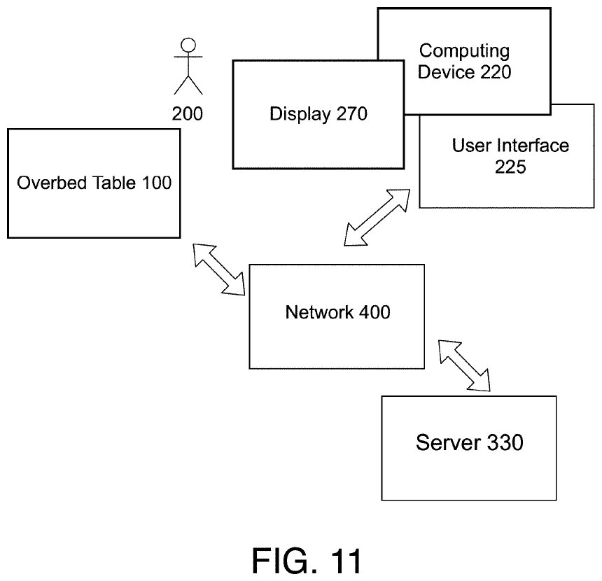

Overbed table 100 may have a control system that may operate to control the actuation of the other systems. Control system may have a series of computing devices which will be discussed in detail later in the description with respect to FIGS. 10-11. Control system may be in the form of, a circuit board, a memory or other non-transient storage medium in which computer-readable coded instructions are stored and one or more processors configured to execute the instructions stored in the memory. Control system may have a wireless transmitter, a wireless receiver, and a related computer process executing on the processors as shown in FIGS. 10-11.

Computing devices in communication with the control system, may be any type of computing device that typically operate under the control of one or more operating systems, which control scheduling of tasks and access to system resources. Computing devices may be a Raspberry Pi® or other computing devices such as but not limited to a phone, tablet, television, desktop computer, laptop computer, gaming system, wearable device electronic glasses, networked router, networked switch, networked, bridge, or any computing device capable of executing instructions with sufficient processor power and memory capacity to perform operations of the control system.

The one or more computing devices may be integrated into the control system, while in other non-limiting embodiments, the control system may be a remotely located computing device or server configured to communicate with one or more other control systems. Control system may also include an internet connection, network connection, and/or other wired or wireless means of communication (e.g., LAN, etc.) to interact with other components. The connection allows patients or healthcare personnel to update, control, send/retrieve information, monitor or otherwise interact passively or actively with the control system for the overbed table 100.

Control system may include control circuitry and one or more microprocessors or controllers acting as a servo control mechanism capable of receiving input from various components of overbed table 100 and generating an output signal to the various components of overbed table 100. The microprocessors (not shown) may have on-board memory to control the power that is applied to the components of overbed table 100 in response to input signals from the patient or health care personnel.

Control system may include circuitry to provide an actuable interface for patient or health care personnel to interact with, including switches and indicators and accompanying circuitry for an electronic control panel or mechanical control panel. Such an actuable interface may present options to patient or health care personnel to select from that would allow patient or health care personnel to control the various components integrated or connected to the overbed table 100 such as a refrigerator 150, a light, an ice and water dispenser 160, charging ports, or tablet in one or more non-limiting embodiments. Control system may be preprogrammed with any references values, by any combination hardwiring, software, firmware to implement various operational modes including but not limited to temperature, light, and humidity values.

The microprocessors in the control system may also monitor the current state of circuitry within the control system to determine the specific mode of operation chosen by the user. For instance, when “on”, the microprocessors may begin autonomously dispensing ice at predetermined intervals. Further, such microprocessors that may be part of control system may receive signals from any of or all components of overbed table 100. Such systems may be notified whether any of the components in the various systems need to be replaced.

As shown in FIG. 1 overbed table 100, in one or more non-limiting embodiments, may include main components, as illustrated in FIG. 1, including a base such as base 110, a support column, such as support column 120, a support surface assembly, such as support surface assembly 130, a power system 140, a refrigerator 150, and a water/ice dispenser 160.

Base 110 may be configured to provide stability to overbed table 100. In one or more non-limiting embodiments, base 110 may be U-shaped or ear shaped with a pair of semi discorectangle spaced apart prongs separated by an interior space whereby the spaced-apart prongs have curved ends at a first end. This particular shape may function to provide additional stability to the overbed table 100. The spaced apart prongs may then terminate into base body at their second end whereby base body is a semi-discorectangle with a curved end at the opposite side of the spaced-apart prongs. Base 110 may be supported by a plurality of wheels or casters which are typically located at the curved ends to facilitate the convenient transportation and positioning of overbed table 100. In the illustrated embodiment, base 110 may be molded piece with a hollow interior such that wiring components may be positioned inside base 110.

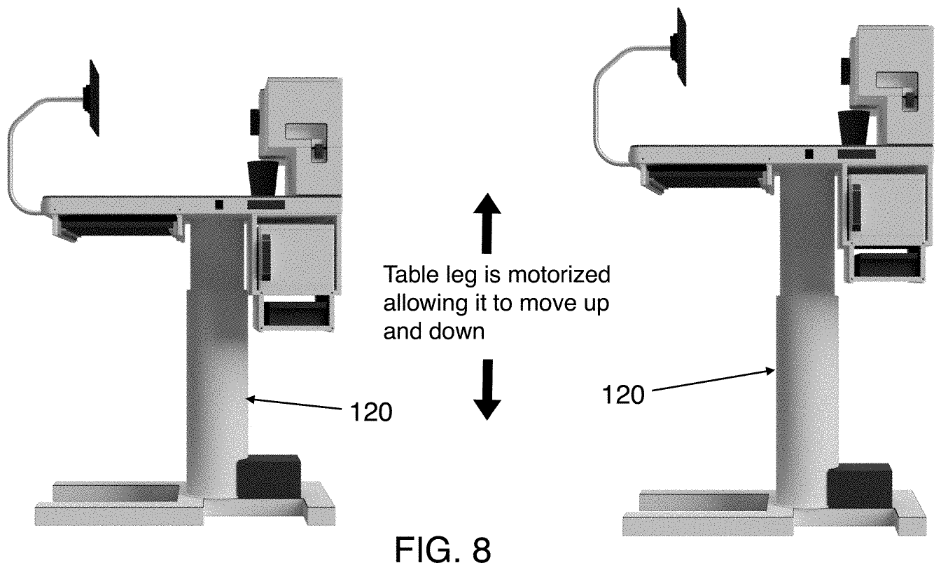

A support column 120 may be supported by base 110 whereby support column 120 may extend vertically upward from base 110 as shown in FIG. 8. Support column 120 may include one or more components such as a lower component and upper component where upper component may move relative to lower component in a linear telescopic motion so that the height of the support column 120 may be adjusted to facilitate the positioning of support surface assembly 130 as may be needed for the convenience by a caregiver or other personnel. The upper and lower components may include columnar or tubular structures with a hollow interior region configured to house circuitry for overbed table 100. Lower component may be connected to a top surface of base 110. In other non-limiting embodiments, support column 120 may have a non-telescoping configuration or may extend at different angles such in order to accommodate different hospital beds.

A lift mechanism (not shown) may be used to adjust the height of support column 120 whereby the lift mechanism causes the raising and lowering of the height of the support column 120. The lift mechanism may be mounted in the interior region of the upper and/or lower component. The lift mechanism may include an electronically driven actuator (such as a linear actuator) that is coupled to the upper and/or lower component and configured to drive the vertical movement of one of the upper component relative to the lower component. A linear actuator may include a rod, one end of which is connected to an upper component, and the other end of which is connected to a motor so that operation of the motor can cause the rod to extend or retract relative to the motor housing. A lift mechanism may be controlled by a control panel or connected device. A lift mechanism may further be actuated by a handle, which allows manual adjustment of the height of the support column as well as by interaction with the control system.

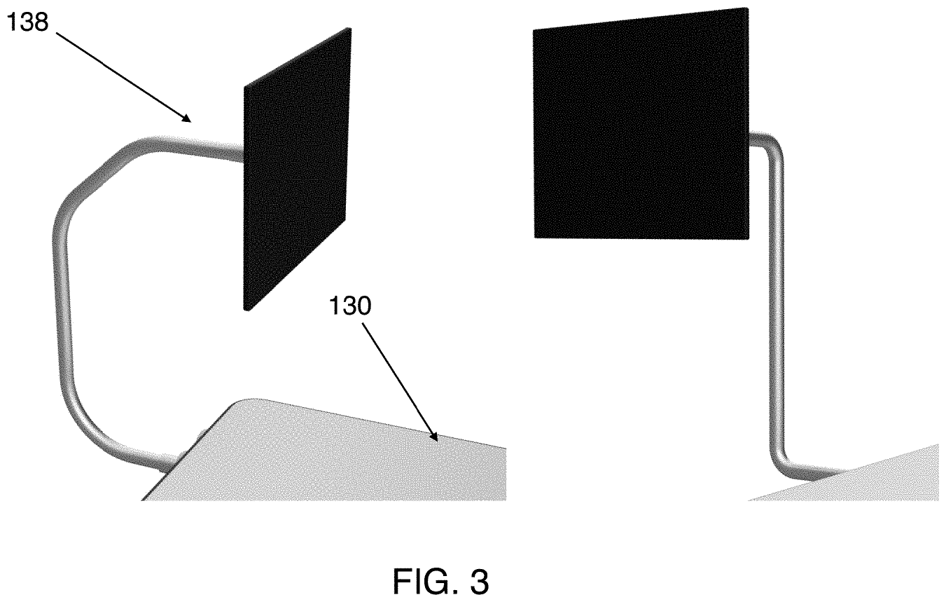

As shown in FIG. 1, support surface assembly 130 may be connected to a top end of the support column 120. Support surface assembly 130 may include a table surface, which can be used as a food tray, work surface, or storage area. Support surface assembly 130 may include one or more non-electrical storage areas designed to store items such as drinking cups, tissues, or other personal items. Support surface assembly 130 may have one or more accessory mounts 138, as illustrated in FIG. 3, may be fastened to support surface assembly 130 whereby accessory mounts 138 may be bent or flexed such that accessory mounts 138 will support the weight of the retained electronic products or accessories without deforming from the chosen configuration unless enough force is applied by user. Accessory mounts 138 may have a gooseneck arm extending from and removably attached to support surface assembly 130. Gooseneck arm may be a spring made of a high-strength steel to provide strength and flexibility and soft galvanized iron wire that is compressed into the gaps of the spring to provide stiffness and to hold accessory mounts' 138 position. Accessory mounts 138 may be connected to one or more storage cases to retain an electronic device such as tablet or video game console whereby the electronic device may be rotated freely for viewing by compromised user 200.

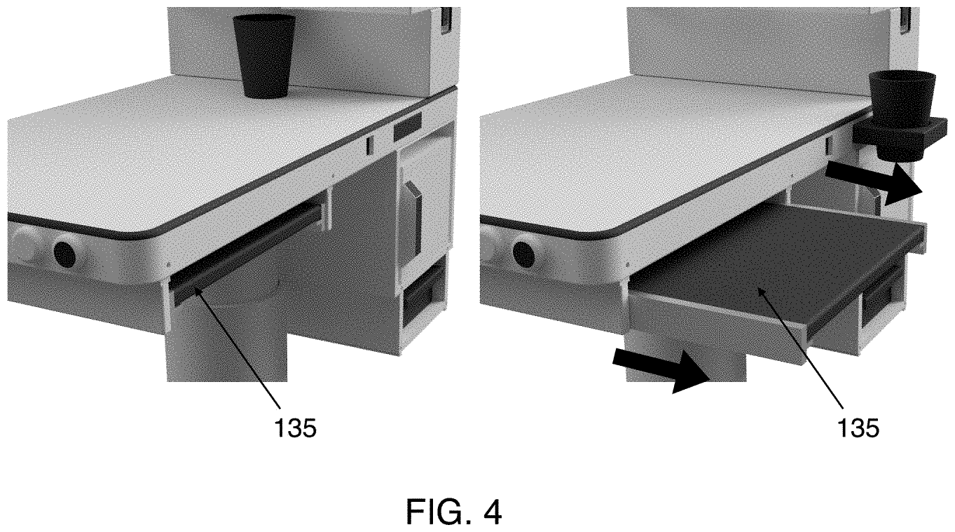

A movable table 139, as illustrated in FIG. 4, may be positioned in the lower receptacle of support surface assembly. Table 139 may have a rectangular shape with a bottom surface and sidewalls, however, table 139 may be designed differently in other embodiments and include other shapes such as a tube or cube or any other shape. Table 139 may be lined with plexiglass or another material to prevent odors and damaging table 139. Pull out slides may be fastened between side walls of support surface assembly 130 such that table 139 may be moved independently from the support surface assembly 130 on either the front or back side of support surface assembly 130. Table 139 is configured to hold one or more contents whereby table 139 allows the contents to be placed on either side of support surface assembly 130. Pull out slides may have one or more stoppers to prevent table 139 from fully extending from support surface assembly 130.

Support surface assembly 130 may have a light source 159 (e.g., a light emitting diode (“LED”) located along the perimeter or attached to support surface assembly 130. Light source 159 may light up or flash colors when certain events occur. In other embodiments, support surface assembly 130 may include a speaker assembly and/or a microphone assembly 169. A speaker assembly may be used to transmit audible sound to the patient or caregiver utilizing the overbed table 100, such that the patient or caregiver may receive notifications or other information as provided through a speaker assembly. Further, the patient or caregiver may relay their own notifications or information using a microphone assembly to transmit their messages. In addition to the above, support surface assembly 130 may have one or more sealable compartments for holding pills or other materials such that the compartments are only accessible at specific times or from approval by care provider.

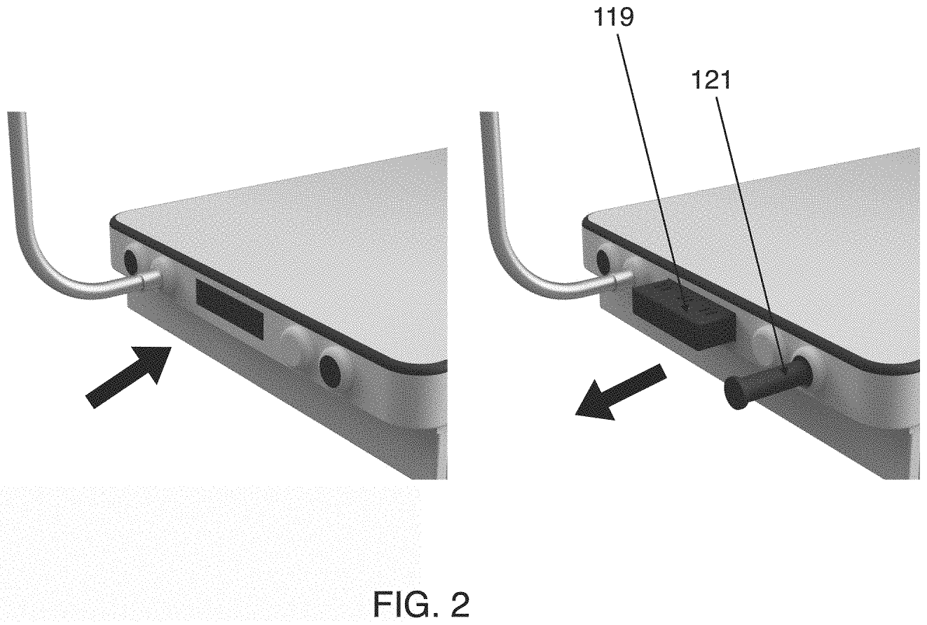

Support surface assembly 130 may further include various electrical power and charging receptacles such as outlet strip 119, as illustrated in FIG. 2, that may be useful to connect to and/or power or recharge an electronic device or a power storage device such as a rechargeable battery that may be connected to the charging receptacles by connecting cords which can transfer direct electrical power to the connected device or may be used to provide charging power to the rechargeable power storage of the connected device. The average length of such connected cords to charging adapters typically ranges from about 1 meters to about 3 meters such that the cords may be accessible for patient while lying on the hospital bed. However, this range is a non-limiting example and the connected cords may be of varying lengths as needed.

One or more ports may be integrated into the side overbed table 100 on outlet strip 119. Outlet strip 119 may include a USB charging receptacle for receiving and connecting to a USB cord allowing communication with one or more electronic devices, such as computers, mobile computing devices, tablets, gaming consoles, cameras, or other computing devices. In one or more embodiments. Outlet strip 119 may be recessed into a cavity within support surface assembly 130. Outer strip 119 may be popped out from support surface assembly 130 by pushing actuator 121 which is connected to a latch. Once actuator 121 is pushed in a latch may be removed from holding outlet strip 119. Springs under compression positioned behind outlet strip 119 and outlet strip 119 will then extend outward. Outlet strip 119 may be pushed back into place, whereby the latch may once again hold outlet strip in place.

Any type of ports and any number of ports may be included with overbed table 100 so as to support charging and providing electrical power to multiple types of computing devices. For example, one or more ports included in the overbed table 100 may include a micro USB charging receptacle for receiving and connecting to a micro USB cord allowing communication with one or more electronic devices. The ports may include a universal serial bus c adapter (USB-C adapter) for receiving and connecting to a USB-C cord allowing communication with one or more electronic devices. The ports may include a lightning adapter for receiving and connecting for receiving and connecting to a lightning cord allowing communication with one or more electronic devices. Lightning connectors are 8-pin connectors which carry a digital signal.

These ports are non-limiting and instead ports may include any number of fiber optic connectors (e.g. TOSLINK), video connectors (e.g. VGA, DVI, S-Video), audio and video connectors (e.g. RCA, HDMI, DisplayPort), data connectors (e.g. IEEE 1394, eSATA), network connectors (e.g. RJ11 phone connector, RJ45 Ethernet connector), or power outlets. The number of power receptacles provided in connection with support surface assembly 130 may also be different. It should be appreciated that other types or configurations of power receptacles (e.g. brand-specific or otherwise) may be used alternatively or in addition to those mentioned herein. Moreover, one or more of such receptacles may be located elsewhere on overbed table 100.

Any included ports included in the overbed table 100 may be protected by a cover, for protection against food, liquids, or other hazards. A cover for protecting one or more ports may have a top component and bottom component be connected using one or more hinges and pins. However, in other non-limiting embodiments snap-fit connections, fasteners, and other attachment mechanisms may be used. A hinge may also be connected so that that top component may be rotated at angle with respect to bottom component and base wherein when in a closed position top component may be parallel to bottom component and when in an open position top component may be at an angle with respect to bottom component. A top component and a bottom component may be preferably connected when closed snap shut type mechanism whereby the top component may be snapped shut with respect to the bottom component and then pulled open by applying upward force on a lip of top component.

In one or more non-limiting embodiments, overbed table 100 may have a refrigerator 150, as shown in FIGS. 1A-FIG. 3, for perishable products. In one example embodiment, refrigerator 150 may have a boxlike shape and may include one or more inner walls, top surface, bottom surface, front surface, and back surface. The boxlike housing of the refrigerator 150 of the overbed table 100 may have one or more partitions and compartments within the refrigerator 150. The refrigerator 150 may further include doors that are attached to the refrigerator 150. Overbed table 100 may have one or more mounting platforms or receptacles to hold refrigerator 150 whereby refrigerator 150 may be detachable from overbed table 100 and different entities may then replace refrigerator 150 such as drawers, microwaves, gaming console holders, or other apparatuses.

One or more conventional latch members may be attached to the door for securing the doors over the open front and back of the box housing and one or more catch members attached to an outer side of one of the outer walls of the box housing to which the latch members are releasably attached. The housing of the refrigerator 150 of the overbed table 100 may also include one or more sheets of insulating material being positioned between the outer and inner walls and the lower floor and upper floor of the box housing. The housing of the refrigerator 150 of the overbed table 100 may further include a magnetized seal member on edges of the inner and outer walls of the box housing to effectively seal the housing upon the doors being securely closed over the open front and back of the box housing.

In one or more non-limiting embodiments, refrigerator 150 may include a motor compressor connected to the motor. Refrigerator 150 may include one or more cooling coils connected to the compressor. Refrigerator 150 may also include one or more condensers that may be located between one of the inner walls and one of the outer walls. Refrigerator 150 may include a fan member connected with a conduit to the condensers member for drawing in air through the condensers between the upper and lower floors. Power system 140 (e.g., as shown in FIGS. 1A-1B) may energize the motor and fan member to the contents inside of refrigerator 150.

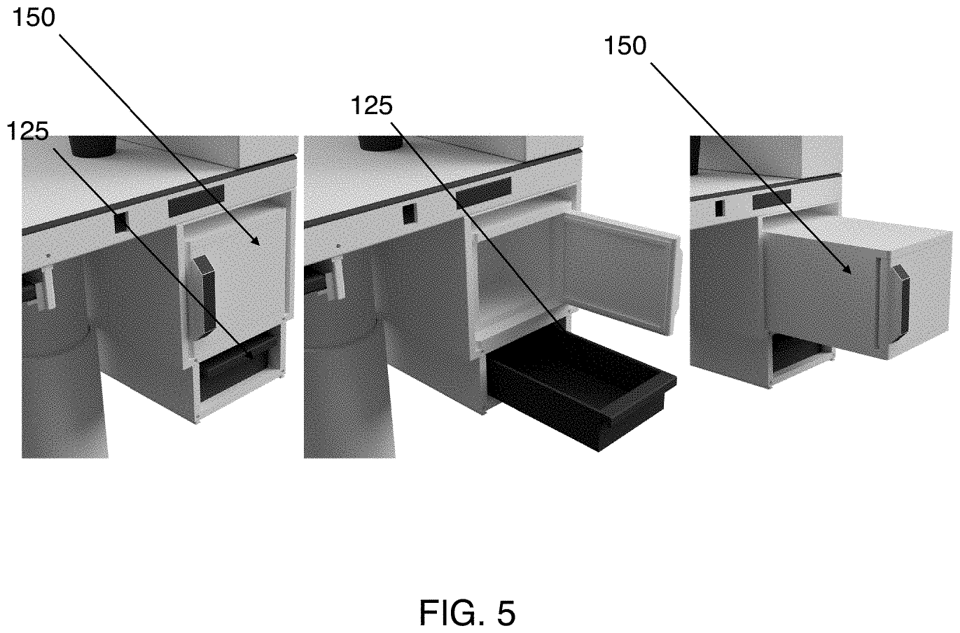

One or more drawers, such as drawer 125, as illustrated in FIG. 5 may be insertable into openings formed by support surfaces attached to bottom of refrigerator 150. One or more support surfaces extend substantially the entire length of the support surface assembly 130. As is illustrated in FIG. 1, support surfaces are of a length and cut such that there is sufficient clearance between drawer 125 and the support surfaces such that drawer may be slid along the support surfaces such that a patient or caregiver may access the contents placed in drawer from either side. In further non-limiting embodiments one or more cup holders, such as cup holders 145, may be insertable into openings formed by support surfaces attached to bottom of support surface assembly 130.

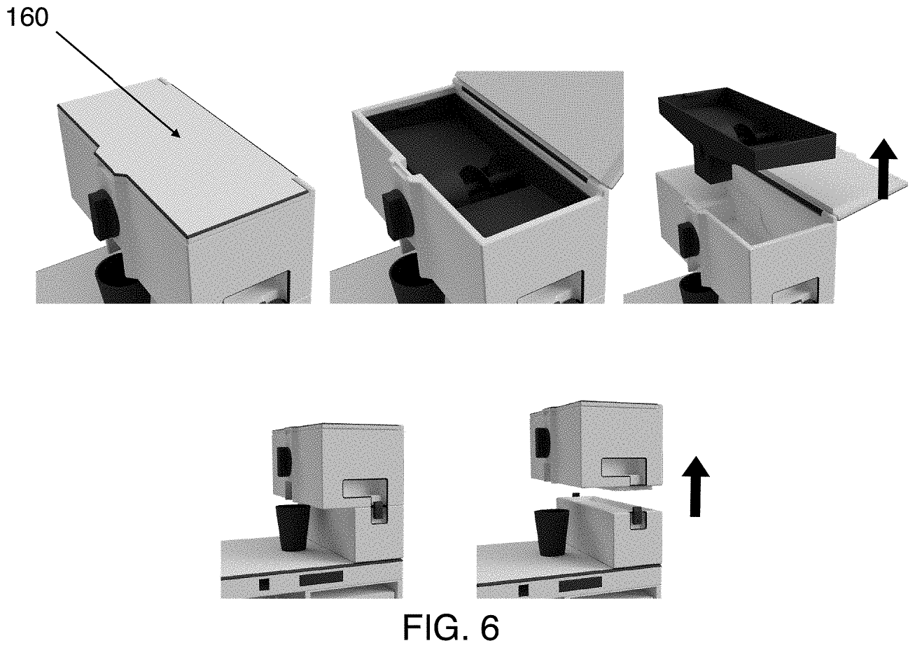

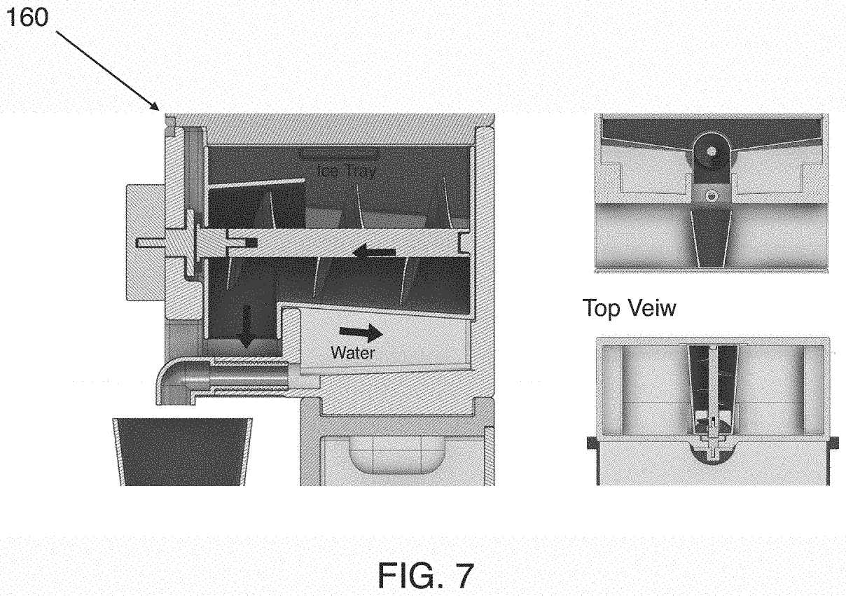

In one or more non-limiting embodiments, overbed table 100 may include a water/ice dispenser 160, as illustrated in FIGS. 6 and 7, connected to support surface assembly 130 by one or more latch mechanisms. In one non-limiting embodiment, water/ice dispenser 160 may include a reservoir to hold an ice tray which may be removed for cleaning. As ice sits in the ice tray in the receptacle and melts the produced water drips into a lower collection area as shown in FIG. 8. The ice tray is structured at an angled such that the gravity moves ice towards the back of it. Water/ice dispenser 160 may have a knob which is rotatable to cause an auger to move ice forward to the front where it may drop into a cup placed on support surface assembly.

In order to transfer a supply of water to the overbed table 100, water/ice dispenser 160 may have a tube that extends to the bottom of the reservoir for the refrigerator 150, whereby the tube is fluidly connected to a pump. The pump may pump water through the tube and into a conduit, whereby the water passes through the conduit and out of an end tip where the water begins to freeze next to a cooling plate and forms ice.

Once ice has formed on the tip of the conduit, the control module actuates a motor to drop the ice, whereby the ice may be ejected through a port of water/ice dispenser 160 and into a storage zone. Weight sensors or timing circuits of the overall control system for the overbed table 100 may be used to coordinate the freezing operations with the delivery of ice particles into storage zone. Water/ice dispenser 160 may have an actuator in the form of a one or more buttons whereby when depressed, a switch in the refrigerator may be activated that operates a valve that may in turn release the collected ice. Further, in one or more non-limiting embodiments, the valve releases water through the connected tubes that run along the back of the refrigerator 150 to pump water from the enclosed reservoir, whereby the water may also be heated by a boiler or any other unit to heat the water and then released out of the water/ice dispenser 160. In other embodiments water/ice dispenser 160 may have a receptacle for holding water or connected to an outside tube or piping to deliver water.

Overbed table 100 may have one or more sensors. Sensor data may be received by one or more computing devices or remotely be received by a server, whereby sensor data is analyzed and the corresponding action or event is determined in response. Sensors may be any type of sensor known in the art. Examples of sensors may include cameras, pressure sensors, GPS, health monitors, Local Positioning System (LPS), altimeters, which can identify where the patient is located in a space, and/or motion sensors (e.g., accelerometers) without limitation. Additionally, in one or more embodiments, the overbed table 100 may include various biometric detection devices such as a blood pressure monitor, a heart rate monitor, a body temperature sensor, a pupillary response detector, a hemoglobin saturation monitor, a skin conductivity monitor, a respiration rate monitor, a brainwave activity inspector, or any other device capable of providing biometric data of compromised user 200 or connected to equipment connected to the patient, whereby the biometric detection devices may send information and data acquired to determine the biostatistics of compromised user 200.

Turning to FIG. 10, FIG. 10 is a block diagram showing various components of computing device 220. Overbed table 100 may be connected to the computing device 220 via one or more ports as discussed above. Further, one or more components integrated into overbed table 100 may operate in conjunction with wireless technologies known in the art such as BLUETOOTH and WIFI, without limitation to these technologies. In some embodiments overbed table 100 may be connected to a remote control capable of the controlling components of overbed table 100.

Computing device 220 may include a housing for containing one or more hardware components. Computing device 220 may include one or more input devices such as input devices 265 that provide input to a CPU (processor) such as CPU 260 of actions related to user 200. Input devices 265 may be implemented as a keyboard, a touchscreen, a mouse, via voice activation, wearable input device, a 3D camera, a trackball, a microphone, a fingerprint reader, an infrared port, a controller, a remote control, a fax machine, and combinations thereof.

The actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen or an LED.

Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display 270 may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application programing interface (API), such as API 286, and other computerized programs or application programs such as application programs 288. Memory 280 may also include data memory such as data memory 290 that may include database query results, configuration data, settings, user options, user preferences, or other types of data, which may be provided to program memory 282 or any element of computing device 220.

Computing device 220 may have a transmitter 295, such as transmitter 295. Transmitter 295 may have a wired or wireless connection and may comprise a multi-band cellular transmitter to connect to the server over 2G/3G/4G/5G cellular networks. Other embodiments may also utilize Near Field Communication (NFC), Bluetooth, or another method to communicate information.

As illustrated in FIG. 11, patient 200 may access to a user interface, such as user interface 225 using computing device 220. User interface 225 may have a plurality of buttons or icons that are selectable to perform particular actions in response to the selections. User interface 225 of computing device 220 may have conventional GUI interface devices such as a title bar, toolbars, pull-down menus, tabs, scroll bars, context help, dialog boxes, operating buttons (icons) and status bar, the user 200 navigates throughout the display.

In some embodiments, overbed table 100 and computing device 220 may be in communication with one or more servers, such as server 330 or one or more networks such as network 400. Server 330 may be located at a data center, or any other location suitable for providing service to network 400 whereby server 330 may be in one central location or in many different locations in multiple arrangements. Server 330 may comprise a database server such as MySQL® or Maria DB® server. Server 330 may have an attached data storage system storing software applications and data. Server 330 may have a number of modules that provide various functions related to interactive overbed table 100. Modules may be in the form of software or computer programs that interact with the operating system of server 330 whereby data collected in databases as instruction-based expressions of components and/or processes may be processed by one or more processors within server 330 or as well as in conjunction with execution of one or more other computer programs. Modules may be configured to receive commands or requests from interactive overbed table 100, computing device 220, server 330, and outside connected devices over network 400. Server 330 may comprise components, subsystems, and modules to support one or more management services for overbed table 100.

In one or more non-limiting embodiments, network 400 may include a local area network (LAN), such as a company Intranet, a metropolitan area network (MAN), or a wide area network (WAN), such as the Internet or World Wide Web. Network 400 may be a private network or a public network, or a combination thereof. Network 400 may be any type of network known in the art, including telecommunications network, a wireless network (including Wi-Fi), and a wireline network. Network 400 may include mobile telephone networks utilizing any protocol or protocols used to communicate among mobile digital user computing devices (e.g. user computing device 104), such as GSM, GPRS, UMTS, AMPS, TDMA, or CDMA. In one or more non-limiting embodiments, different types of data may be transmitted via network 400 via different protocols. In alternative embodiments, user computing devices 220, may act as standalone devices or whereby they may operate as peer machines in a peer-to-peer (or distributed) network environment.

Network 400 may further include a system of terminals, gateways, and routers. Network 400 may employ one or more cellular access technologies including 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between user computing devices if for instance they are in a remote location not accessible by other networks.

Computing device 220 or server 330 may have one or more modules operable to perform and implement various types of function, actions, and operations for having a processor which may execute from received data from overbed table 100 and control overbed table 100 to operate refrigerator 150, ice/water dispenser 160, and any other electronic components associated with overbed table 100 remotely.

Different states of overbed table 100 may be displayed by different indicators through user interface 225, whereby control system receives data from the sensors, analyzes the data, and presents the data in the form of status indicators to user 200 through user interface 225 of computing device 220. User interface 225 may have an adjustable timer component for each component where the timer component may enable input from user 200 for the control system to delay state changes when operating. User interface 225 may further include a calendar or be synchronized with an outside calendar to display user 200's activities for a set period of time. An overall control system for the overbed table 100 may be customized through user interface 225 to be active or inactive during these user activities to provide services to user 200, whereby user 200 may be reminded of needing to drink water or other activities.

Many uses and advantages are offered by the one or more non-limiting embodiments in the present description for the overbed table 100. Overbed table 100 may be used in a hospital setting or any other location wherever needed. Overbed table 100 may be particularly useful for patients requiring care, convalescence, and recovery, however, overbed table 100 may also be beneficial to any type of user who desires a table such as overbed table 100 that includes the many helpful components and can be used by the user when lying in a bed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. An overbed table, the overbed table comprising:
a base;
a support column extending upwardly from the base; and
a support surface assembly connected to the support column.

2. The overbed table of claim 1, wherein the base has a pair of semi discorectangle spaced apart prongs separated by an interior space wherein the prongs at a first end have curved ends.

3. The overbed table of claim 2, wherein the base is connected to a plurality of wheels for transporting the overbed table.

4. The overbed table of claim 3, wherein the support column has a lower component and upper component where the upper component is movable in relation to the lower component in a linear telescopic motion so that a height of the support column is increasable or decreasable.

5. The overbed table of claim 1, wherein the support surface assembly has one or more drawers, wherein the one or more drawers are insertable into openings in the support surface assembly.

6. The overbed table of claim 1, wherein the support surface assembly has a table that is extendable at a front and back end of the support surface assembly.

7. The overbed table of claim 1, wherein the support surface assembly has one or more retractable cup holders.

8. The overbed table of claim 1, wherein the support surface assembly has one or more light sources attached to a perimeter of a top surface of the support surface assembly.

9. The overbed table of claim 8, wherein the one or more light sources are connected to a control system, wherein the control system performs steps of: flashing colors when events occur with equipment for treating a patient.

10. The overbed table of claim 1, wherein the support surface assembly has one or more power and charging receptacles.

11. The overbed table of claim 10, wherein the one or more power and charging receptacles include a usb port, usb-c port, micro usb, and a lightning port.

12. The overbed table of claim 1, wherein the support surface assembly has a speaker assembly and microphone assembly for sending and receiving notifications concerning a patient.

13. The overbed table of claim 1, wherein the support surface assembly has a refrigerator.

14. The overbed table of claim 13, wherein the refrigerator is detachable and has two hinged doors on a front surface and a back surface.

15. The overbed table of claim 14, wherein the refrigerator has one or more partitions and compartments within the refrigerator.

16. The overbed table of claim 15, wherein the support surface assembly has a water dispenser.

17. The overbed table of claim 16, wherein the water dispenser is connected to the refrigerator by one or more tubes, the one or more tubes in fluid communication with a pump.

18. An overbed table, the overbed table comprising:
a base;
a support column extending upwardly from the base;
a support surface assembly connected to the support column;
one or more drawers for storage included within the support surface assembly;
a refrigerator;
a retractable tab e;
a water dispenser and ice maker; and
one or more ports for connecting to one or more computing devices.

19. The overbed table of claim 18, wherein the support surface assembly has one or more light sources attached to a perimeter of a top surface of the support surface assembly, wherein the one or more light sources are connected to a control system, wherein the control system performs steps of: flashing colors when events occur with equipment for treating a patient, wherein the support surface assembly has a speaker assembly and microphone assembly for sending and receiving notifications concerning the patient.

20. The overbed table of claim 19, wherein the refrigerator is detachable and has two hinged doors on a front and a back surface, wherein the water dispenser is connected to the refrigerator by one or more tubes, the one or more tubes in fluid communication with a pump.
